(19) United States
(12) Patent Application Publication
(10) Pub. No.: US 2010/0226032 A1
(43) Pub. Date: Sep. 9, 2010

(54) CONTROL DEVICE, MAGNETIC DISK DEVICE, AND IW SENSITIVITY CALCULATING METHOD

(75) Inventor: Hiroaki SATO, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/718,775

(22) Filed: Mar. 5, 2010

(30) Foreign Application Priority Data
Mar. 6, 2009 (JP) 2009-052975

(51) Int. Cl. G11B 5/02; G11B 27/36

(52) U.S. Cl. 360/31; 360/59; G9B/5.026; G9B/27.052

(57) ABSTRACT

According to one embodiment, a control device includes a writer, a setting module, a reader, and an Iw sensitivity acquiring module. The writer writes a signal by the magnetic head. The setting module sets an electric parameter to the magnetic head. The reader reads the signal by the magnetic head. The Iw sensitivity acquiring module acquires Iw sensitivity of the magnetic head. The Iw sensitivity acquiring module includes a first acquiring module, a second acquiring module, and an Iw sensitivity calculator. The first acquiring module acquires a predetermined output value related to control of a signal having a predetermined frequency. The second acquiring module acquires a predetermined output value related to control of the signal having the predetermined frequency. The Iw sensitivity calculator calculates the Iw sensitivity of the magnetic head based on the predetermined output values acquired by the first and second acquiring modules.

### CROSS-REFERENCE TO RELATED APPLICATIONS

This application is based upon and claims the benefit of priority from Japanese Patent Application No. 2009-52975, filed Mar. 6, 2009, the entire contents of which are incorporated herein by reference.

### BACKGROUND

1. Field

One embodiment of the invention relates to a control device, a magnetic disk device, and an Iw sensitivity calculating method.

2. Description of the Related Art

To ensure the reliability of a magnetic disk device, technology for controlling the head flying height has been known. As one example of such technology, dynamic fly height (DFH) has been known. The DFH is a technology for protruding a head element at a front end of a head by heat emitted from a heater incorporated in the head. The DFH will be specifically described using FIG. 16. FIG. 16 illustrates an example of the DFH.

As illustrated in FIG. 16, the DFH thermally expands an insulating film having a head element (a write core and a read core) located at a front end of a slider by the heater to protrude the head element, and controls the flying height. In the DFH, the insulating film is expanded by heat generated when a current flows through the head element as well as by heat from the heater. That is, the protrusion amount in the DFH is based on a write current (Iw) and heater power. For this reason, the DFH calculates the protrusion amount based on Iw sensitivity indicating a relationship between the write current and the protrusion amount, and controls the heater power to achieve the target flying height. In the DFH, the Iw sensitivity used in the calculation of the protrusion amount is an average value based on Iw sensitivity measured by a testing machine with respect to a plurality of devices and plurality of heads.

The Iw sensitivity includes Iw protrusion sensitivity (unit: nm/mA) that indicates the protrusion amount in a write current per 1 mA and Iw heater sensitivity (unit: mW/mA) obtained by converting the Iw protrusion sensitivity into heater power.

In the magnetic disk device, a technology has been known in which a change in the TPR amount due to a write operation is measured, the measurement result is stored in a memory or a magnetic disk, and the flying height is managed using the data (for example, see Japanese Patent Application Publication (KOKAI) No. 2005-71546).

In the conventional DFH, the Iw sensitivity is fixed to a previously calculated average. However, since the Iw sensitivity varies depending on each head, sensitivity differs between the actual Iw sensitivity and the fixed Iw sensitivity. If the Iw sensitivity is measured by a measuring instrument for each head, a large amount of time and cost are required.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view of the hardware configuration of a magnetic disk device according to a first embodiment of the invention;

FIG. 2 is an exemplary view of the hardware configuration of a read channel in the first embodiment;

FIG. 3 is an exemplary view of the hardware configuration of a read/write head in the first embodiment;

FIG. 4 is an exemplary block diagram of the functional configuration of the magnetic disk device in the first embodiment;

FIG. 5 is an exemplary flowchart of the operation of the magnetic disk device in the first embodiment;

FIG. 6 is an exemplary view of a state of a read/write head during a write operation of an observed pattern in the first embodiment;

FIG. 7 is an exemplary view of a state of a read/write head during a read operation of an observed pattern in the first embodiment;

FIG. 8 is an exemplary view of a write gate and a read gate in switching of operation mode from write operation to read operation in the first embodiment;

FIG. 9 is an exemplary view of an Iw sensitivity calculation expression in the first embodiment;

FIG. 10 is an exemplary view of correlation information according to a second embodiment of the invention;

FIG. 11 is an exemplary view of an approximated curve calculation expression in the second embodiment;

FIG. 12 is an exemplary flowchart of the operation of a magnetic disk device in the second embodiment;

FIG. 13 is an exemplary view of a read operation of an observed pattern according to a third embodiment of the invention;

FIG. 14 is an exemplary view of a preamble in servo gain according to a fourth embodiment of the invention;

FIG. 15 is an exemplary view of a relationship between heater power or a write current and gain in the fourth embodiment; and

FIG. 16 is an exemplary view of DFH.

### DETAILED DESCRIPTION

Various embodiments according to the invention will be described hereinafter with reference to the accompanying drawings. In general, according to one embodiment of the invention, a control device of a magnetic disk device controls the flying height of a magnetic head by heat from a heater. The control device comprises a writer, a setting module, a reader, and an Iw sensitivity acquiring module. The writer is configured to write a signal by the magnetic head. The setting module is configured to set a predetermined electric parameter to the magnetic head. The reader is configured to read the signal by the magnetic head. The Iw sensitivity acquiring module is configured to acquire Iw sensitivity of the magnetic head. The Iw sensitivity acquiring module comprises a first acquiring module, a second acquiring module, and an Iw sensitivity calculator. The first acquiring module is configured to write a signal having a predetermined frequency to a first track by the writer, set a first electric parameter to the magnetic head by the setting module, write a signal to a second track by the writer, and acquire a predetermined output value related to control of the signal having the predetermined frequency written to the first track read by the reader. The second acquiring module is configured to set a second electric parameter to the magnetic head by the setting module, write a signal to the second track by the writer, and acquire a predetermined output value related to control of the signal having the predetermined frequency written to the first track read by the reader. The Iw sensitivity calculator is configured to calculate the Iw sensitivity of the magnetic head based on the predetermined output value acquired by the first acquiring module and the predetermined output value acquired by the second acquiring module.

According to another embodiment of the invention, a magnetic disk device that controls the flying height of a magnetic head by heat from a heater. The magnetic disk device comprises a writer, a setting module, a reader, and an Iw sensitivity acquiring module. The writer is configured to write a signal by the magnetic head. The setting module is configured to set a predetermined electric parameter to the magnetic head. The reader is configured to read the signal by the magnetic head. The Iw sensitivity acquiring module is configured to acquire Iw sensitivity of the magnetic head. The Iw sensitivity acquiring module comprises a first acquiring module, a second acquiring module, and an Iw sensitivity calculator. The first acquiring module is configured to write a signal having a predetermined frequency to a first track by the writer, set a first electric parameter to the magnetic head by the setting module, write a signal to a second track by the writer, and acquire a predetermined output value related to control of the signal having the predetermined frequency written to the first track read by the reader. The second acquiring module is configured to set a second electric parameter to the magnetic head by the setting module, write a signal to the second track by the writer, and acquire a predetermined output value related to control of the signal having the predetermined frequency written to the first track read by the reader. The Iw sensitivity calculator is configured to calculate the Iw sensitivity of the magnetic head based on the predetermined output value acquired by the first acquiring module and the predetermined output value acquired by the second acquiring module.

According to still another embodiment of the invention, there is provided an Iw sensitivity calculating method applied to a magnetic disk device that controls the flying height of a magnetic head by heat from a heater. The Iw sensitivity calculating method comprises: first writing a signal having a predetermined frequency to a predetermined first track by the magnetic head; first setting a predetermined first parameter to the magnetic head; second writing a signal to a second track different from the first track by the magnetic head where the first parameter is set at the first setting; first reading the signal having the predetermined frequency written to the first track at the first writing by the magnetic head with a flying height upon writing of the signal at the second writing; first acquiring a predetermined output value related to control of the signal read at the first reading; second setting a second parameter different from the first parameter to the magnetic head; third writing a signal to the second track by the magnetic head where the second parameter is set at the second setting; second reading the signal having the predetermined frequency written to the first track at the first writing by the magnetic head with a flying height upon writing of the signal at the third writing; second acquiring a predetermined output value related to control of the signal read at the second reading; and calculating Iw sensitivity of the magnetic head from a correlation between amplitude of the signal read by the magnetic head and the predetermined output value based on the predetermined output value acquired at the first acquiring and the second acquiring.

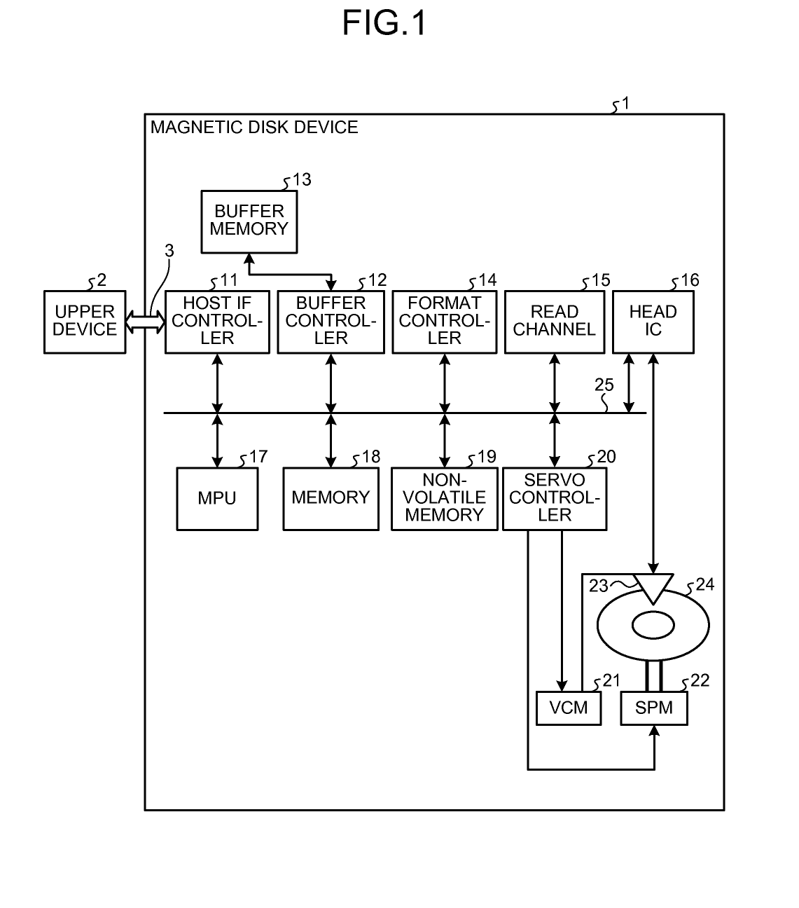

The hardware configuration of a magnetic disk device according to a first embodiment of the invention will be described. FIG. 1 illustrates the hardware configuration of the magnetic disk device of the first embodiment.

As illustrated in FIG. 1, an upper device 2 and a magnetic disk device 1 are connected through a host interface (IF) 3. The upper device 2 is a personal computer that comprises the magnetic disk device 1 as a storage device, and issues a command to the magnetic disk device 1 to read/write data.

The magnetic disk device 1 comprises a host interface (IF) controller 11, a buffer controller 12, a buffer memory 13, a format controller 14, a read channel 15, a head integrated circuit (IC) 16, a micro processor unit (MPU) 17 (control device), a memory 18, a non-volatile memory 19, a servo controller 20, a voice coil motor (VCM) 21, a spindle motor (SPM) 22, a read/write head 23 (magnetic head), a disk medium 24, a bus 25, and a host interface (IF) 3.

The host IF 3 is used to exchange data or a command between the magnetic disk device 1 and the upper device 2. The host IF controller 11 controls the data or the command transmitted to the upper device 2 through the host IF 3. The host IF controller 11 controls the data or the command transmitted from the upper device 2 and received by the host IF 3. The buffer controller 12 controls write or read of data stored in the buffer memory 13. The buffer memory 13 temporarily stores data written to the disk medium 24 or data read from the disk medium 24. The format controller 14 generates a write format of the data written to the disk medium 24. The read channel 15 converts the data written to the disk medium 24 into a signal, and converts a signal read from the disk medium 24 into data.

The head IC 16 amplifies a signal written to the disk medium 24 and a signal read from the disk medium 24 by the read/write head 23. The MPU 17 controls the overall operation of the magnetic disk device 1. The memory 18 is a volatile memory. The non-volatile memory 19 stores a program used to control the magnetic disk device 1. The servo controller 20 controls the operation of the VCM 21 and the SPM 22. The VCM 21 drives the read/write head 23. The SPM 22 rotates and drives the disk medium 24. The read/write head 23 writes a signal as data to the disk medium 24 or reads the data recorded on the disk medium 24 as the signal. The disk medium 24 is one of storage media to record data. The bus 25 is used to exchange information, such as the data or the command, among the host IF controller 11, the buffer controller 12, the format controller 14, the read channel 15, the head IC 16, the MPU 17, the memory 18, the non-volatile memory 19, and the servo controller 20.

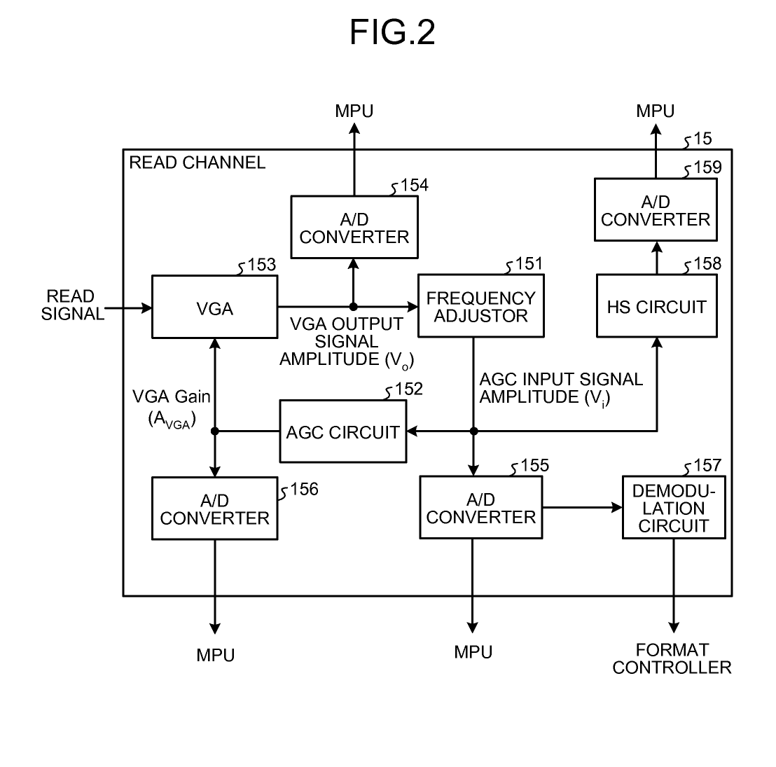

The hardware configuration of the read channel 15 will be described. FIG. 2 illustrates the hardware configuration of the read channel 15.

As illustrated in FIG. 2, the read channel 15 comprises a frequency adjustor 151, an automatic gain control (AGC) circuit 152, a variable gain amplifier (VGA) 153, an A/D converter 154, an A/D converter 155, an A/D converter 156, a demodulation circuit 157, a harmonic sensor (HS) circuit 158, and an A/D converter 159.

The frequency adjustor 151 adjusts a frequency of a VGA output signal from the VGA 153. The AGC circuit 152 determines gain with respect to an AGC input signal output from the frequency adjustor 151, and outputs VGA gain, which is a control signal indicating the gain, to the VGA 153. The VGA 153 amplifies a read signal read from the disk medium 24 by the read/write head 23 based on the VGA gain output from the AGC circuit 152, and outputs the read signal as a VGA output signal. The A/D converter 154 performs an A/D conversion on amplitude of the VGA output signal output from the VGA 153, and outputs a converted value (Vₒ) to the MPU 17. The A/D converter 155 performs the A/D conversion on the amplitude of the VGA output signal output from the frequency adjustor 151, and outputs a converted value (V₁) to the MPU 17 and the demodulation circuit 157. The A/D converter 156 performs the A/D conversion on the VGA gain output from the AGC circuit 152, and outputs a converted value (A_{VGA}) to the MPU 17. The demodulation circuit 157 demodulates the signal subjected to the A/D conversion by the A/D converter 155, and outputs the demodulated signal as read data to the format controller 14. The HS circuit 158 outputs a voltage based on the frequency of the signal output from the frequency adjustor 151. The A/D converter 159 performs the A/D conversion on the voltage output from the HS circuit 158, and outputs the converted voltage to the MPU 17.

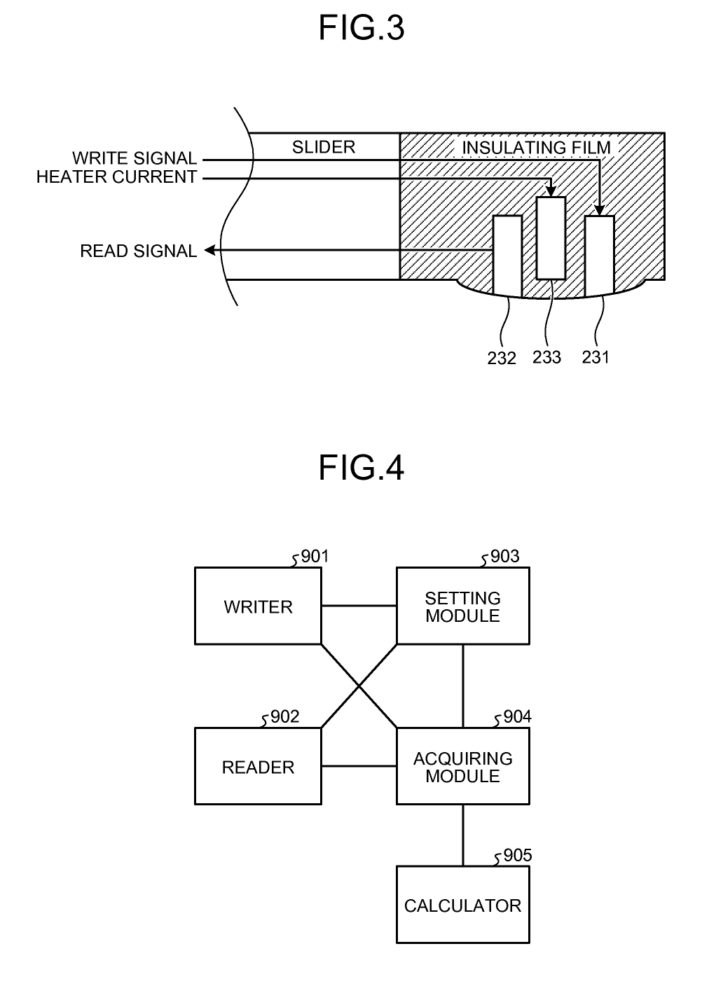

The hardware configuration of the read/write head 23 will be described. FIG. 3 illustrates the hardware configuration of the read/write head 23.

As illustrated in FIG. 3, the read/write head 23 comprises a slider mounted to an arm and an insulating film located at a front end of the slider. In the insulating film, a write core 231, a read core 232, and a heater 233 are provided. The write core 231 is an element that converts a write signal into magnetism and writes the write signal to the disk medium 24. The read core 232 is an element that converts the magnetism written to the disk medium 24 into a signal and reads the signal as a read signal. The heater 233 expands the insulating film by heating the insulating film according to the supplied heater power, and adjusts the flying height of the read/write head 23 with respect to the disk medium 24. The write core 231 generates heat when the signal is written to the disk medium 24, and the insulating film is expanded by the heat. Accordingly, when the flying height is adjusted by the heater 233, Iw sensitivity of the write core 231 is added.

The functional configuration of the magnetic disk device 1 of the first embodiment will be described. FIG. 4 is a block diagram of the functional configuration of the magnetic disk device 1 of the first embodiment.

As illustrated in FIG. 4, the magnetic disk device 1 of the first embodiment comprises a writer 901, a reader 902, a setting module 903, an acquiring module 904, and a calculator 905 as functions. The writer 901 writes a signal in the disk medium 24 by the read/write head 23. The reader 902 reads a signal from the disk medium 24 by the read/write head 23. The setting module 903 sets a write current (electric parameter) of the read/write head 23. The acquiring module 904 acquires a VGA gain value, an AGC input signal amplitude value, and a VGA output signal amplitude value. The acquiring module 904 instructs the writer 901 to write a signal, the reader 902 to read a signal, and the setting module 903 to set a write current. The calculator 905 calculates Iw sensitivity, based on the value acquired by an acquiring module 906, and acquires the Iw sensitivity. The individual modules are functions that are substantially realized by the MPU 17.

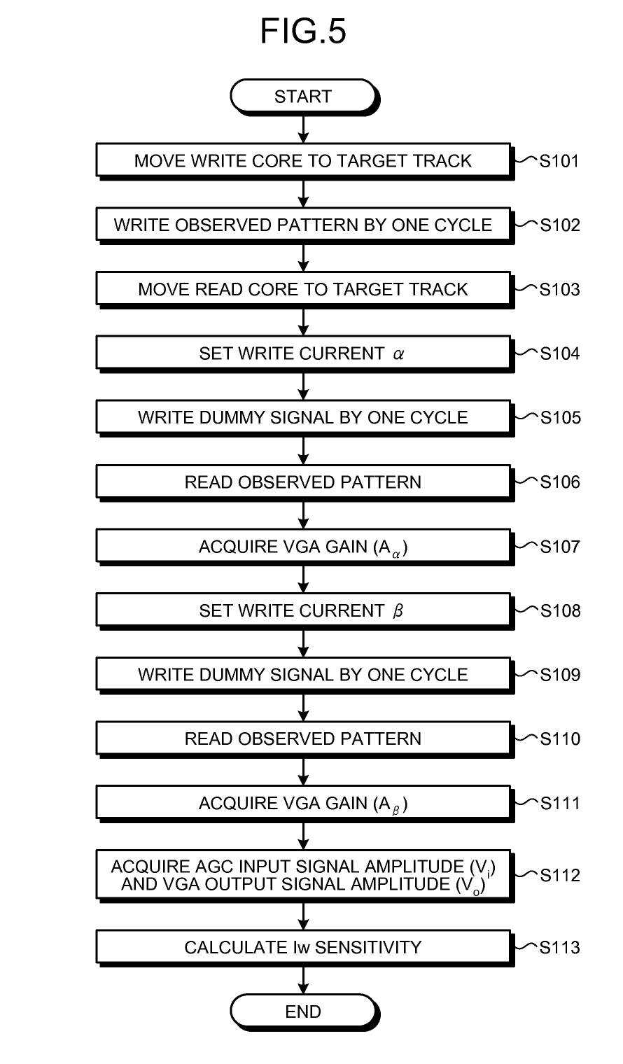

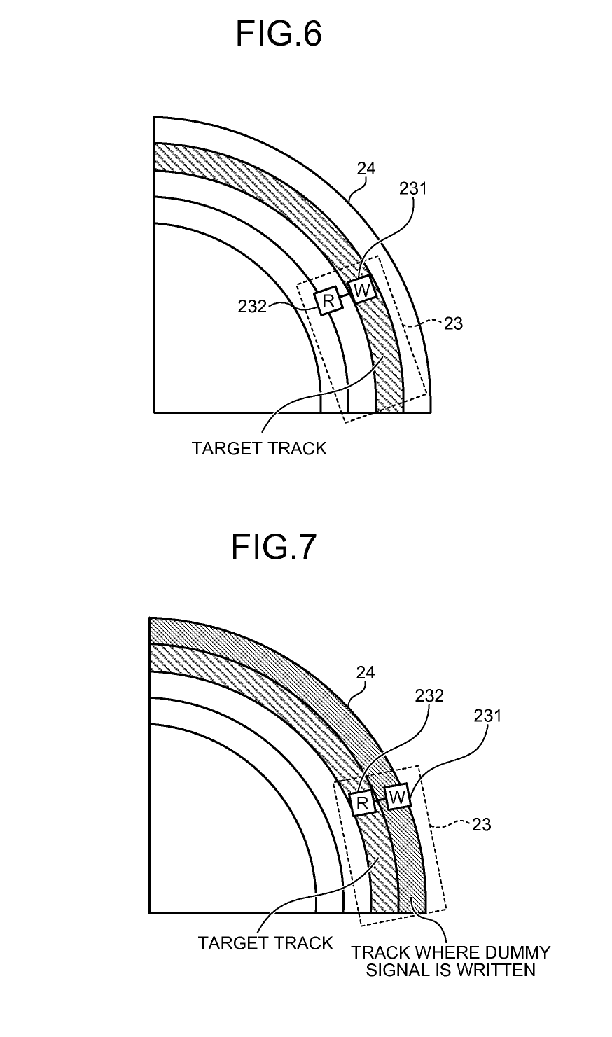

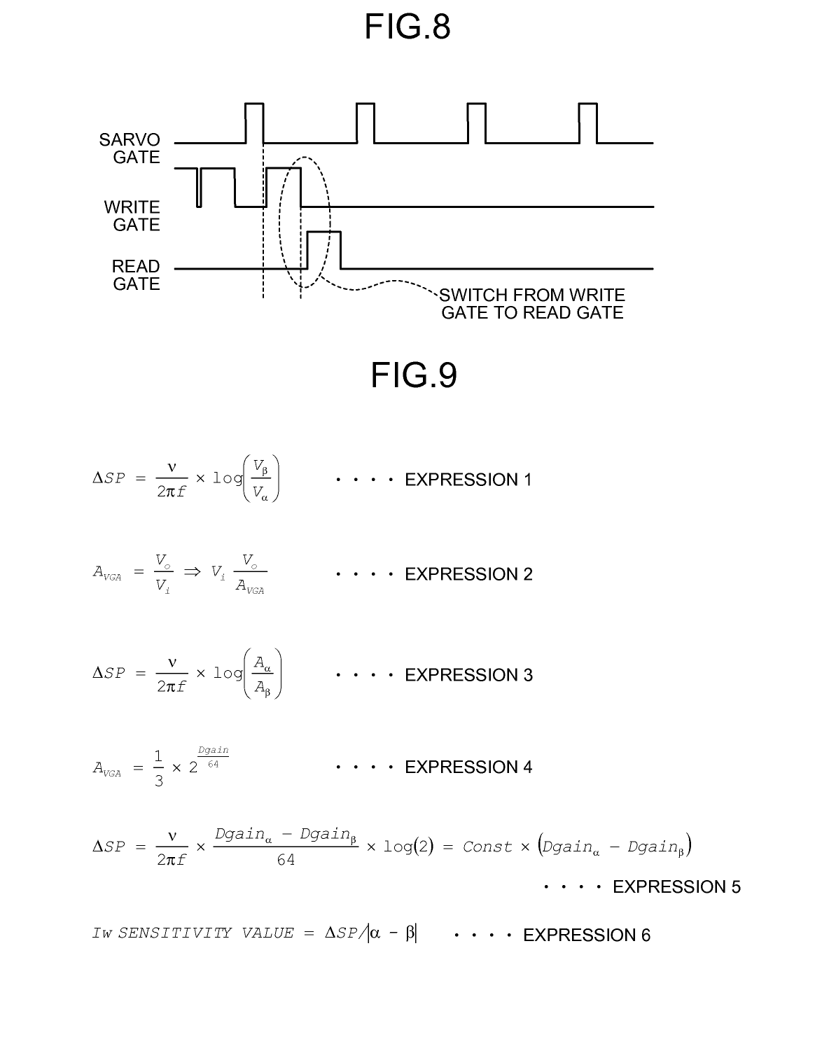

Next, the operation of the magnetic disk device 1 of the first embodiment illustrated in FIG. 5 will be described with reference to FIGS. 6 to 9. FIG. 5 is a flowchart of the operation of the magnetic disk device of the first embodiment. FIG. 6 illustrates a state of the read/write head during a write operation of an observed pattern. FIG. 7 illustrates a state of the read/write head during a read operation of an observed pattern. FIG. 8 illustrates a write gate and a read gate in switching of an operation mode from a write operation to a read operation. FIG. 9 illustrates an Iw sensitivity calculation expression.

First, as illustrated in FIG. 6, the writer 901 controls the read/write head 23 through the servo controller 20 such that the write core 231 is positioned on a target track (S101). Next, the writer 901 writes an observed pattern in the target track by the read/write head 23 by one cycle (S102). The observed pattern may be a signal having a constant frequency. In the first embodiment, it is assumed that a signal having a frequency of F2 is used.

Next, as illustrated in FIG. 7, the reader 902 controls the read/write head 23 through the servo controller 20 such that the read core 232 is positioned on the target track (S103). Next, the writer 901 sets a (first electric parameter) as a write current (S104), and writes a dummy signal in the disk medium 24 by the read/write head 23 by one cycle (S105). Next, the reader 902 reads the observed pattern written to the target track (S106), and the acquiring module 904 acquires the VGA gain in reading of the observed pattern as Aα (S107).

The flying height of the read/write head 23 can be adjusted to the flying height corresponding to the write current α by the writing of the dummy signal. The track where the dummy signal is written is a track where the write core 231 is positioned when the read core 232 is positioned on the target track. As illustrated in FIG. 8, the write operation of the dummy signal is switched to the read operation of the observed pattern without seek control between the write gate and the read gate. By this switching operation, a difference between the flying height at the time of writing the dummy signal and the flying height at the time of reading the observed pattern can be reduced as compared with the case where the seek control is performed.

Next, the setting module 903 sets β (second electric parameter), which is different from α, as the write current (S108), and writes a dummy signal in the disk medium 24 by the read/write head 23 by one cycle (S109). Next, the reader 902 reads the observed pattern written to the target track (S110). At this time, the acquiring module 904 acquires VGA gain (Aβ) in reading of the observed pattern (S111), and acquires the AGC input signal amplitude (Vᵢ) and the VGA output signal amplitude (Vₒ) (S112).

Next, the calculator 905 calculates Iw sensitivity, based on the acquired Aα, Aβ, Vᵢ, and Vₒ (S113). The calculation of the Iw sensitivity will be described in detail below. When the Iw sensitivity is calculated, an expression of Wallace is used. Read of the observed pattern set to the flying height of the write current α is set to a condition α, and read of the observed pattern set to the flying height of the write current β is set to a condition β. In this case, a correlation exists between an amplitude ratio of the read signals under the two conditions and a difference of the flying heights. The correlation is represented by Expression 1 of FIG. 9, when the difference of the flying heights is defined as ΔSP, a frequency (frequency of F2 in the first embodiment) of the read/write signal is defined as f, a speed of a measured spot is defined as v, amplitude of the read signal under the condition α is defined as Vα, and amplitude of the read signal under the condition β is defined as Vβ. A relationship between the VGA gain (A_{VGA}), the AGC input signal amplitude (Vᵢ), and the VGA output signal amplitude (Vₒ) is represented by Expression 2 of FIG. 9. In this case, if Vₒ is set to a fixed value and Expression 1 is converted using the VGA gain (Aα) under the condition α and the VGA gain (Aβ) under the condition β, ΔSP is represented by Expression 3. A relationship between the VGA gain (A_{VGA}) and D (Differential) gain is represented by Expression 4.

If the D gain under the condition a is defined as Dgainα and the D gain under the condition β is defined as Dgainβ, ΔSP is calculated by Expression 5. As illustrated in Expression 6, if ΔSP is divided by an absolute value of the difference of the write current α and the write current β, the Iw protrusion sensitivity is calculated. If the different heater powers instead of the different write currents are set as the conditions α and β, the Iw heater sensitivity can be calculated.

As described above, the Iw sensitivity (Iw protrusion sensitivity or Iw heater sensitivity) is calculated based on the gain in the reading of the observed pattern in the flying height under the different conditions (write current or heater power). Therefore, the appropriate Iw sensitivity can be calculated for each read/write head without using the measuring instrument. Since the Iw sensitivity can be calculated by the magnetic disk device, in a user environment, even when the Iw sensitivity changes due to aging of the read/write head or an external factor, the Iw sensitivity can be recalculated, and the appropriate flying height can be set based on the Iw sensitivity.

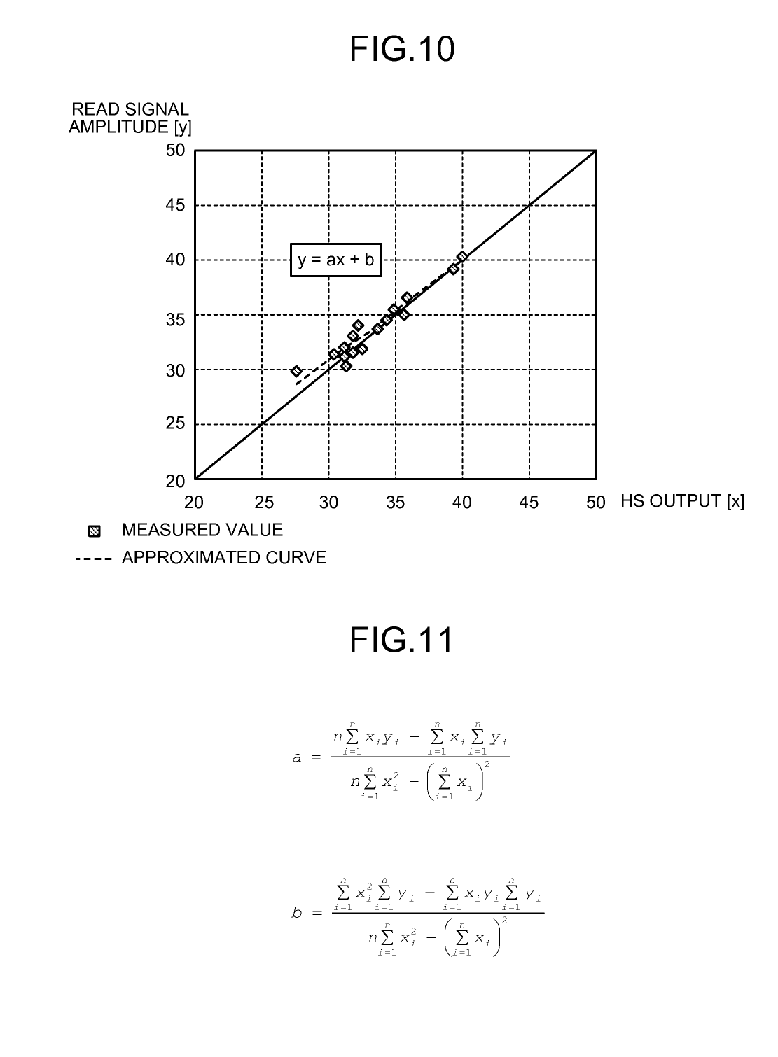

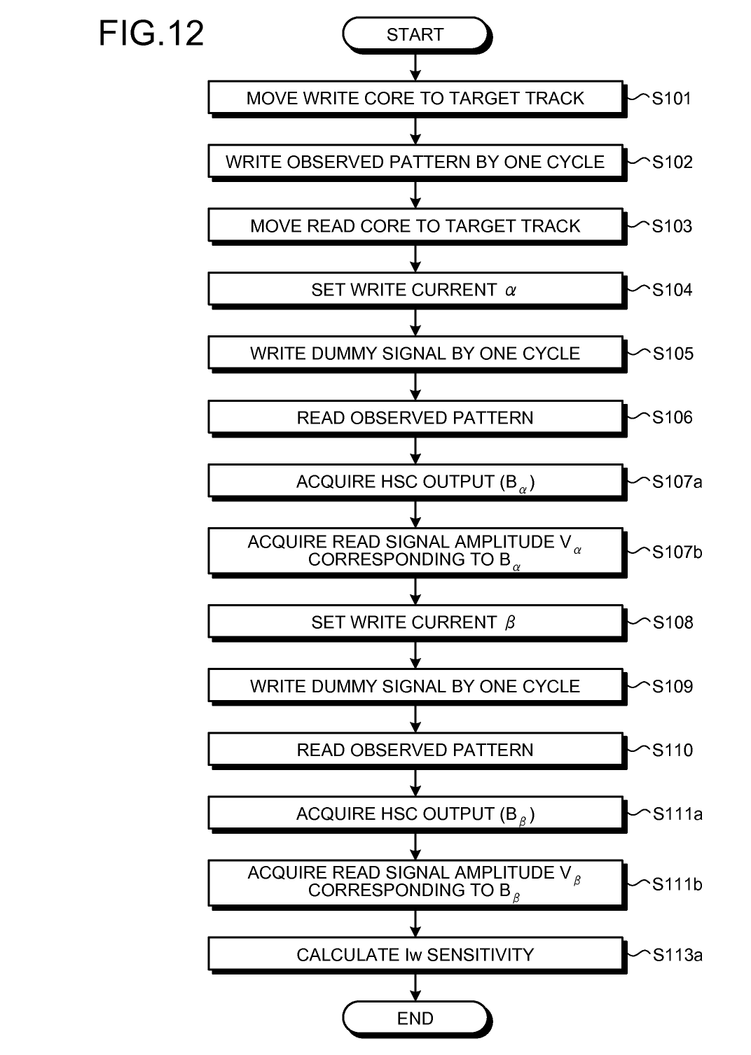

A second embodiment of the invention will be described. In the first embodiment, the VGA gains (Aα and Aβ) are used in the calculation of the amplitude ratio of the read signals. The second embodiment is different from the first embodiment in that the amplitude ratio of the read signals is calculated based on an output (HSC output) from the HS circuit. The difference from the first embodiment will be described. FIG. 10 illustrates correlation information. FIG. 11 illustrates an approximated curve calculation expression. FIG. 12 is a flowchart of the operation of a magnetic disk device of the second embodiment.

First, to calculate the amplitude ratio of the read signals based on the HSC output, information (hereinafter, “correlation information”) indicating a correlation between the HSC output and the read signal amplitude illustrated in FIG. 10 is stored in the memory 18 of the magnetic disk device 1. The correlation information may be stored in a system area of the disk medium 24. In the second embodiment, the correlation information is an approximated curve (primary expression) based on HSC output values measured several times in advance and amplitude values of the read signals corresponding to the HSC output values. When the read signal amplitude value is defined as y, the HSC output value is defined as x, and constants are defined as a and b, the approximated curve is represented by an expression of y=ax+b. The constants a and b are calculated by a least-square method. Specifically, the constants a and b are calculated by expressions illustrated in FIG. 11. In these expressions, x indicates an HSC output value, y indicates a read signal amplitude value, and n indicates a measurement count.

In a state where the correlation information is stored in advance in the memory 18, the operation illustrated in FIG. 12 is performed. In the operation of the magnetic disk device 1 of the second embodiment, since S101 to S106 and S108 to S110 are the same as those of the first embodiment, the description will not be repeated. Only the difference from the first embodiment will be described.

As illustrated in FIG. 12, if the observed pattern written by the write current α is read, the acquiring module 904 acquires an HSC output value Bα in the reading of the observed pattern (S107a), and refers to the correlation information to acquire the read signal amplitude Vα corresponding to Bα (S107b).

If the observed pattern written by the write current β is read, the acquiring module 904 acquires an HSC output value Bβ in the reading of the observed pattern (S111a), and refers to the correlation information to acquire the read signal amplitude Vβ corresponding to Bβ (S111b).

Next, the calculator 905 calculates Iw sensitivity based on the acquired Vα and Vβ (S113a). The calculation of the Iw sensitivity will be described in detail below. In the calculation of the Iw sensitivity in the second embodiment, the expression of Wallace is used as in the first embodiment. In the second embodiment, the read signal amplitude value is used in the calculation of the Iw sensitivity. The second embodiment is different from the first embodiment in that the value acquired in Expression 1 can be substituted. Basically, the Iw protrusion sensitivity can be calculated in the same manner as the first embodiment. Similar to the first embodiment, the different heater powers instead of the different write currents are set as the conditions α and β, and the Iw heater sensitivity can be calculated.

As described above, the Iw sensitivity (Iw protrusion sensitivity or the Iw heater sensitivity) can be calculated based on the HSC output with respect to the read signal of the observed pattern in the flying height under the different condition (write current or heater power). Therefore, the appropriate Iw sensitivity can be calculated for each read/write head without using the measuring instrument.

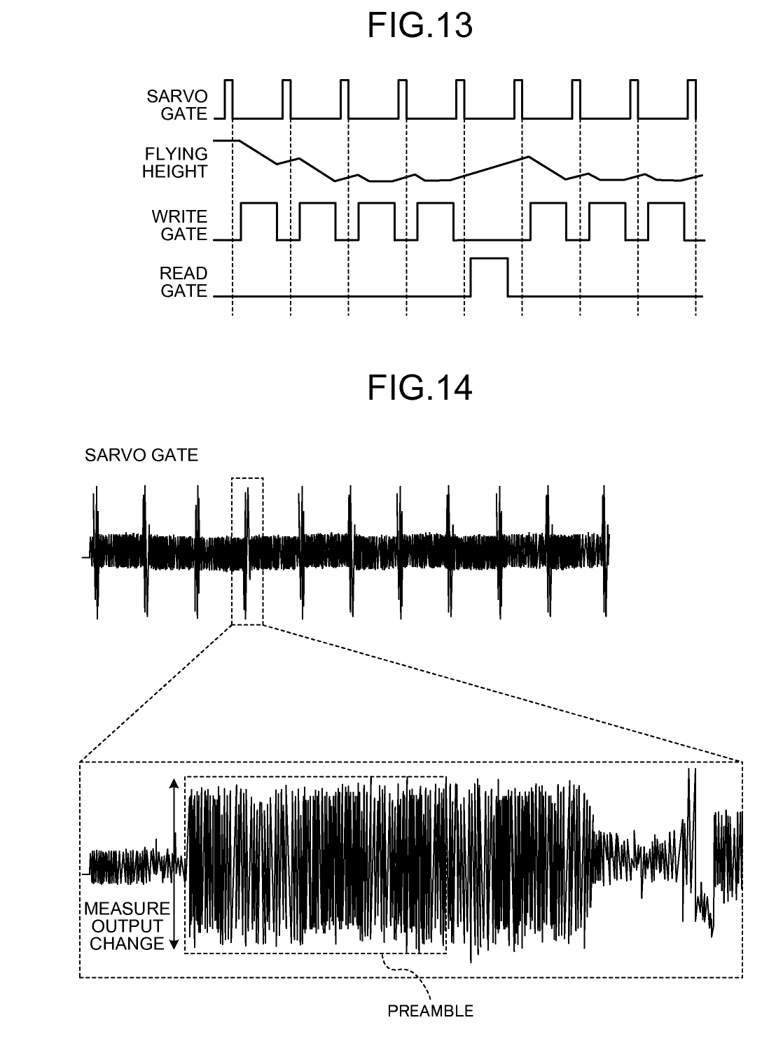

A third embodiment of the invention will be described. In the first and second embodiments, the write of the dummy signal and the read of the observed pattern are performed in a track unit, i.e., a cycle unit, under the conditions α and β. In the third embodiment, the write of the dummy signal and the read of the observed pattern are performed in a servo frame unit several times, and a sum or an average of the VGA gain (or read signal amplitude) obtained by reading the observed pattern is set as the VGA gain (or read signal amplitude) under each condition. Hereinafter, the read of the observed pattern, the addition, and the average in the third embodiment will be described. FIG. 13 illustrates a read operation of an observed pattern in the third embodiment.

In the third embodiment, the write operation of the dummy signal by the writer 901 and the read operation of the observed pattern by the reader 902 are performed with an arbitrary servo frame. In FIG. 13, the read operation of the observed pattern is performed once for every 5 servo frames. That is, after the dummy signal is written by the four servo frames, the read operation of the observed pattern corresponding to one servo frame is performed. The reader 902 reads the observed pattern of the servo frame unit several times.

With respect to the read operation of the observed patterns, the acquiring module 904 acquires the read value (the VGA gain or the value of the read signal amplitude based on the HSC output) several times. The acquiring module 904 sets the sum or the average of the read values acquired several times as the read value. In the case of the addition, instead of the specific write current (or heater power), a range of the write current is set to each condition, and the variation of the read value by the write current (or heater power) increased in a predetermined unit in the range is added. Specifically, when the range of the write current is 1 to 3 mA, the write current increases in the order of 1 mA, 2 mA, and 3 mA, the variation of the read value in the individual write current is added, and the sum becomes the read value under each condition. In the case of the average, in each condition, an average of the read values of the observed pattern is used as the read value. In this manner, the added or averaged read value is set as the read value in each condition, which improves precision of the finally calculated Iw sensitivity. If the read operation of the observed pattern is performed in a servo frame unit, a read time can be shortened.

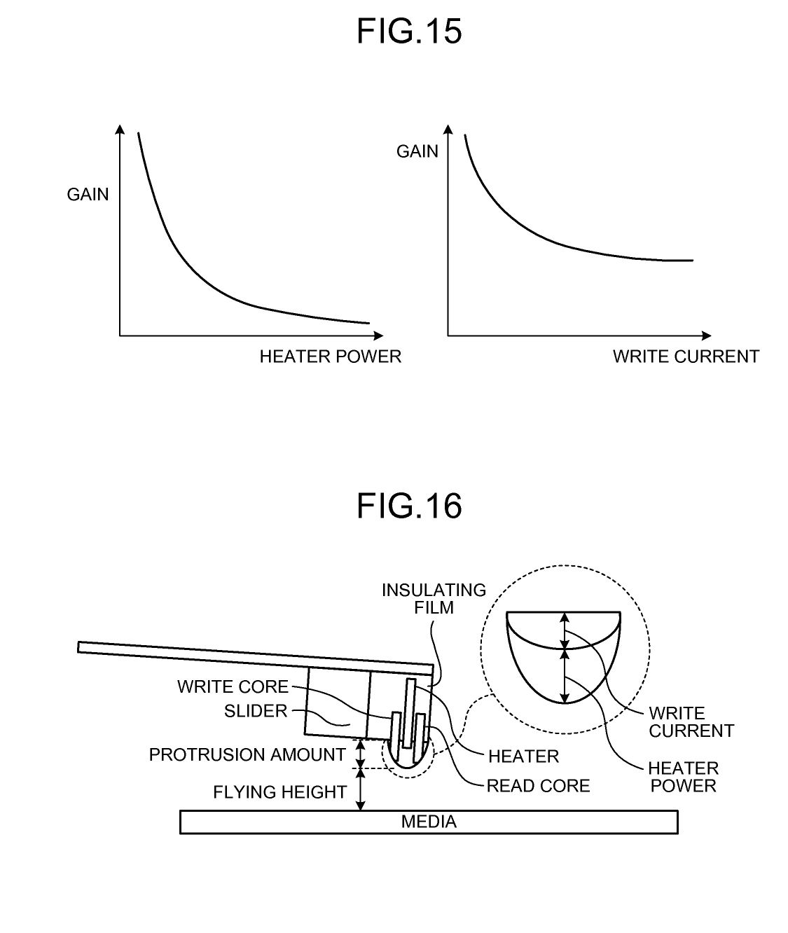

A fourth embodiment of the invention will be described. The fourth embodiment is different from the first embodiment in that a servo track is used as the observed pattern. FIG. 14 illustrates a preamble in servo gain. FIG. 15 illustrates a relationship between heater power or a write current and gain in the fourth embodiment.

In the fourth embodiment, the magnetic disk device 1 uses a preamble portion of servo position information, which is previously written using a servo track writing (STW) method at the time of manufacturing the disk, as an observed pattern. The acquiring module 904 acquires VGA gain of the preamble of the servo pattern in the reading of the observed pattern under each condition, as illustrated in FIG. 14. As illustrated in FIG. 15, since the VGA gain of the preamble is correlative with the write current or the heater power, the Iw sensitivity can be measured based on the VGA gain of the preamble.

As described above, if the Iw sensitivity is calculated based on the output value related to the control of the read signal, the appropriate Iw sensitivity can be set to each head in the magnetic disk device.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A control device of a magnetic disk device configured to control a flying height of a magnetic head by heat from a heater, the control device comprising:
a writer configured to write a signal by the magnetic head;
a setting module configured to set a predetermined electric parameter to the magnetic head;
a reader configured to read the signal by the magnetic head; and
a write current (Iw) sensitivity receiver configured to receive Iw sensitivity of the magnetic head,
wherein the Iw sensitivity receiver comprises:
a first receiver configured to write a signal comprising a predetermined frequency to a first track by the writer, to set a first electric parameter to the magnetic head by the setting module, to write a signal to a second track by the writer, and to receive a predetermined first output value related to control of the signal comprising the predetermined frequency written to the first track and read by the reader,
a second receiver configured to set a second electric parameter to the magnetic head by the setting module, to write a signal to the second track by the writer, and to receive a predetermined second output value related to control of the signal comprising the predetermined frequency written to the first track and read by the reader, and
an Iw sensitivity calculator configured to calculate the Iw sensitivity of the magnetic head based on the first and second predetermined output values.

2. The control device of claim 1, wherein the predetermined electric parameter is a write current in the magnetic head.

3. The control device of claim 1, wherein the first and second predetermined output values are gains of the signals read by the magnetic head.

4. The control device of claim 1, wherein the first and second predetermined output values are output values of a harmonic sensor circuit with respect to the signals read by the magnetic head.

5. The control device of claim 1, wherein the first receiver and the second receiver are configured to cause the reader to read signals comprising the predetermined frequency a plurality of times, and to set averages of predetermined output values related to control of the signals as the first and second predetermined output values.

6. The control device of claim 1, wherein the first receiver and the second receiver are configured to cause the reader to read signals comprising the predetermined frequency a plurality of times, and to set sums of deviations in the first and second predetermined output values related to control of the signals as the first and second predetermined output values.

7. The control device of claim 1, wherein the electric parameter is power of the heater.

8. A magnetic disk device configured to control a flying height of a magnetic head by heat from a heater, the magnetic disk device comprising:
a writer configured to write a signal by the magnetic head;
a setting module configured to set a predetermined electric parameter to the magnetic head;
a reader configured to read the signal by the magnetic head; and
a write current (Iw) sensitivity receiver configured to receive Iw sensitivity of the magnetic head,
wherein the Iw sensitivity receiver comprises:
a first receiver configured to write a signal comprising a predetermined frequency to a first track by the writer, to set a first electric parameter to the magnetic head by the setting module, to write a signal to a second track by the writer, and to receive a predetermined first output value related to control of the signal comprising the predetermined frequency written to the first track and read by the reader,
a second receiver configured to set a second electric parameter to the magnetic head by the setting module, to write a signal to the second track by the writer, and to receive a second predetermined output value related to control of the signal comprising the predetermined frequency written to the first track and read by the reader, and
an Iw sensitivity calculator configured to calculate the Iw sensitivity of the magnetic head based on the first and second predetermined output values.

9. The magnetic disk device of claim 8, wherein the predetermined electric parameter is a write current in the magnetic head.

10. The magnetic disk device of claim 8, wherein the first and second predetermined output values are gains of the signals read by the magnetic head.

11. The magnetic disk device of claim 8, wherein the predetermined output values are output values of a harmonic sensor circuit with respect to the signals read by the magnetic head.

12. The magnetic disk device of claim 8, wherein the first receiver and the second receiver are configured to cause the reader to read signals comprising the predetermined frequency a plurality of times, and to set averages of predetermined output values related to control of the signals as the first and second predetermined output values.

13. The magnetic disk device of claim 8, wherein the first receiver and the second receiver are configured to cause the reader to read signals comprising the predetermined frequency a plurality of times, and to set sums of deviations in the first and second predetermined output values related to control of the signals as the first and second predetermined output values.

14. The magnetic disk device of claim 8, wherein the electric parameter is power of the heater.

15. A write current (Iw) sensitivity calculating method of a magnetic disk device configured to control a flying height of a magnetic head by heat from a heater, the Iw sensitivity calculating method comprising:
first writing a signal comprising a predetermined frequency to a predetermined first track by the magnetic head;
first setting a predetermined first parameter to the magnetic head;
second writing a signal to a second track different from the first track by the magnetic head where the first parameter is set at the first setting;
first reading the signal comprising the predetermined frequency written to the first track at the first writing with a flying height upon writing of the signal at the second writing;
first receiving a first predetermined output value related to control of the signal read at the first reading;
second setting a second parameter different from the first parameter to the magnetic head;
third writing a signal to the second track by the magnetic head where the second parameter is set at the second setting;
second reading the signal comprising the predetermined frequency written to the first track at the first writing with a flying height upon writing of the signal at the third writing;
second receiving a second predetermined output value related to control of the signal read at the second reading; and
calculating Iw sensitivity of the magnetic head from a correlation between amplitude of the signal read by the magnetic head and the first and second predetermined output values.

16. The Iw sensitivity calculating method of claim 15, wherein the first parameter and the second parameter are a write current in the magnetic head.

17. The Iw sensitivity calculating method of claim 15, wherein the first and second predetermined output values are gains of the signal read by the magnetic head.

18. The Iw sensitivity calculating method of claim 15, wherein the first and second predetermined output values are output values of a harmonic sensor circuit with respect to the signal read by the magnetic head.

19. The Iw sensitivity calculating method of claim 15, wherein
the first reading and the second reading comprise reading signals comprising the predetermined frequency a plurality of times, and
the first receiving and the second receiving comprise setting averages of first and second predetermined output values related to control of the signals as the first and second predetermined output values.

20. The Iw sensitivity calculating method of claim 15, wherein
the first reading and the second reading comprise reading signals comprising the predetermined frequency a plurality of times, and
the first receiving and the second receiving comprise setting sums of deviations in the first and second predetermined output values related to control of the signals as the first and second predetermined output values.
